(19) United States
(12) Patent Application Publication
(10) Pub. No.: US 2012/0199603 A1
(43) Pub. Date: Aug. 9, 2012

(54) AUTOMATIC DUAL FUNCTION DISPENSER

(75) Inventors: Leonardo Antonio Avezzano, San Severo (IT); Massimo Ballerini, Poretta Terme (IT)

(73) Assignee: KONINKLIJKE PHILIPS ELECTRONICS N.V., EINDHOVEN (NL)

(21) Appl. No.: 13/501,196

(22) PCT Filed: Oct. 15, 2010
(86) PCT No.: PCT/IB2010/054675

§ 371 Date: Apr. 10, 2012

(30) Foreign Application Priority Data
Oct. 20, 2009 (IT) FI2009A000225

(51) Int. Cl. G07F 9/10; G07F 11/56; G07F 13/06

(52) U.S. Cl. 221/96

(57) ABSTRACT

The automatic dispenser (1) comprises a first dispensing unit (3) for dispensing solid or packaged food products and a second dispensing unit (5) for dispensing drinks, overlapped to the first dispensing unit. The second dispensing unit (5) is turnably mounted relative to the first dispensing unit (3), for allowing back access to the second dispensing unit without moving the first dispensing unit.

### FIELD OF THE INVENTION

The present invention relates to automatic dispensers, also called vending machines, for dispensing food products. More in particular, the invention relates to automatic dual function dispensers, that is, intended for dispensing packaged or solid food products, such as snacks, packaged drinks or others, and drinks, typically hot drinks, and in particular coffee and/or other coffee-based drinks.

### PRIOR ART

Automatic dispensers are frequently used in public places and communities for dispensing paid food products, with coin payment systems, diminishing card or the like. There are automatic dispensers for dispensing packaged or solid products, such as snacks or similar packaged products, canned or bottled drinks and others. Other types of automatic dispensers are used for making and dispensing drinks, in particular for making and dispensing coffee, cappuccino, hot milk, chocolate, or tea and other drinks, for example those obtained from the solubilisation of freeze-dried products, cold drinks like fruit juices or others.

Recently, dual automatic dispensers have also been developed which exhibit a dispenser of solid or packaged food products, combined with a drink dispenser.

Automatic solid or packaged food dispensers exhibit such a structure that the parts and the inside components and devices are accessible through a front door for maintenance and for recharging products or for other works. Automatic drink dispensers, on the other hand, exhibit a very complex structure such that maintenance and product recharging requires front access and, depending on the type of works to carry out, the removal of inside parts. In fact, the complexity and the number of components require an overlapped assembly of the same components. Maintenance, cleaning and recharge works therefore require long times and complex operations, which require personnel with special expertise to be performed.

In order to overcome this drawback, an automatic dispenser has recently been developed wherein at least a part of the inside components are mounted on a frame revolving within an enclosure, space or container forming the outer structure of the automatic dispenser (see WO-A-2008/067843).

### SUMMARY OF THE INVENTION

The object of an embodiment of the invention is to improve composite automatic dispensers, comprising a first dispensing unit for dispensing solid or packaged food products and a second dispensing unit for dispensing drinks, overlapped to one another, so as to facilitate and speed up maintenance works, the filling of tanks or containers of ingredients for making the drinks, cleaning and other.

Substantially, according to an embodiment, the invention provides for an automatic dispenser comprising a first dispensing unit for dispensing solid or packaged food products and a second dispensing unit for dispensing drinks, overlapped to the first dispensing unit, wherein the second dispensing unit is turnably mounted relative to the first dispensing unit for allowing back access to the second dispenser without moving the first dispensing unit.

In some embodiments, the second dispensing unit comprises a space for seating members and ingredient tanks for making drinks, which space is turnably mounted on the containment structure of the first dispensing unit.

In some embodiments, the second dispensing unit is turnable about a substantially vertical axis and is supported on a substantially horizontal wall of the first dispensing unit.

According to a preferred embodiment, the second dispensing unit comprises: a front door provided with an access for taking the drinks prepared and dispensed by the second dispensing unit; and a back closing door; said front door and said back door being openable for allowing access to the inside members of said second dispensing unit. This provides for an increased accessability and/or serviceability.

Further advantageous features and embodiments of the invention are indicated in the annexed dependent claims, which form an integral part of the present description.

### BRIEF DESCRIPTION OF THE DRAWINGS

The invention will be better understood by following the description and accompanying drawing, which shows a non-limiting practical embodiment of the invention. More in particular, in the drawing they show:

FIG. 1 a front view of an automatic dual dispenser with the top dispensing unit frontally open;

FIG. 2 an axonometric view of the automatic dispenser of FIG. 1;

FIG. 3 an axonometric view of the same automatic dispenser in a step of rotation of the top dispensing unit relative to the bottom dispensing unit;

FIG. 4 an axonometric view of the automatic dispenser with the top dispensing unit fully rotated relative to its standard operating position; and

FIG. 5 a side partial section view schematically showing a possible exemplary embodiment of the turnable connecting support between the top dispensing unit and the bottom dispensing unit.

### DETAILED DESCRIPTION OF EMBODIMENTS OF THE INVENTION

The automatic dispenser shown in the drawings, globally indicated with reference numeral 1, exhibits a first bottom dispensing unit 3 and a second top dispensing unit 5. In some embodiments, the bottom dispensing unit 3 is a unit that dispenses solid or packaged food products, typically snacks. In other embodiments, the bottom dispensing unit 3 may be arranged for dispensing bottled or canned drinks The possibility of providing a dispensing unit that dispenses both drinks and solid packaged foods is not excluded. Such dispensing unit may exhibit an in se known structure and therefore, it shall be described only briefly.

In some embodiments, the dispensing unit 3 comprises, in a per se known manner, a front door 7 with a central door 9 closed by an oscillating element that allows access to an inside space wherein the products selected by the user through a front interface of the automatic dispenser 1 are discharged. The central door 9 may be associated to per se known system that prevent access to the overlying products, typically contained in one or more shelves visible from the outside through a window 11 that allows the user to select the product. If the automatic dispenser 1 is setup to store perishable food products, or to dispense drinks packaged at a low temperature, in the bottom side the dispensing unit 3 may exhibit a space 13 for seating a refrigerating unit that keeps the internal volume of the same dispensing unit 3 at a low temperature. The configuration of the inside parts of the dispensing unit 3 is per se known and shall not be described in greater detail herein.

The second top dispensing unit 5 is designed for dispensing drinks. More in particular, in the example shown the dispensing unit 5 is made for dispensing various types of hot drinks, in particular coffee, cappuccino, hot milk, chocolate in cups, tea or others. The inside components of automatic dispensers for making and dispensing drinks are per se known. Only a brief description thereof shall be given herein, and limited to few main components, sufficient for understanding the objects of the present invention and the way of achieving them.

The top dispensing unit 5 exhibits a main body 15 consisting of a space or enclosure for seating the inside components, among which the elements and the devices for making drinks and the tanks for the ingredients. Frontally, enclosure 15 is closed by a front door 17 with an opening 17A wherethrough the user can take the container, for example a cup or a glass, wherein the drink prepared by the dispensing unit 5 is dispensed. Above opening 17A on door 17 there is an interface 19 that allows the user to select the product to be dispensed, either a drink prepared by the dispensing unit 5, or a solid or packaged food product dispensed by the dispensing unit 3. Interface 19 may exhibit a keyboard, a display, a payment system, for example with coins or card and any other accessories required for operating the automatic dispenser 1. For simplicity and clarity reasons, the drawings only show openings or slits for seating these possible components. The possibility of arranging the user interfaces for selecting the products and/or the payment mechanisms in different points of the dispenser, for example in a side space applied on a wall of enclosure 15, or above it, or also associated to the bottom dispensing unit. Also, the position schematically shown in the annexed drawings allows obtaining greater ergonomy.

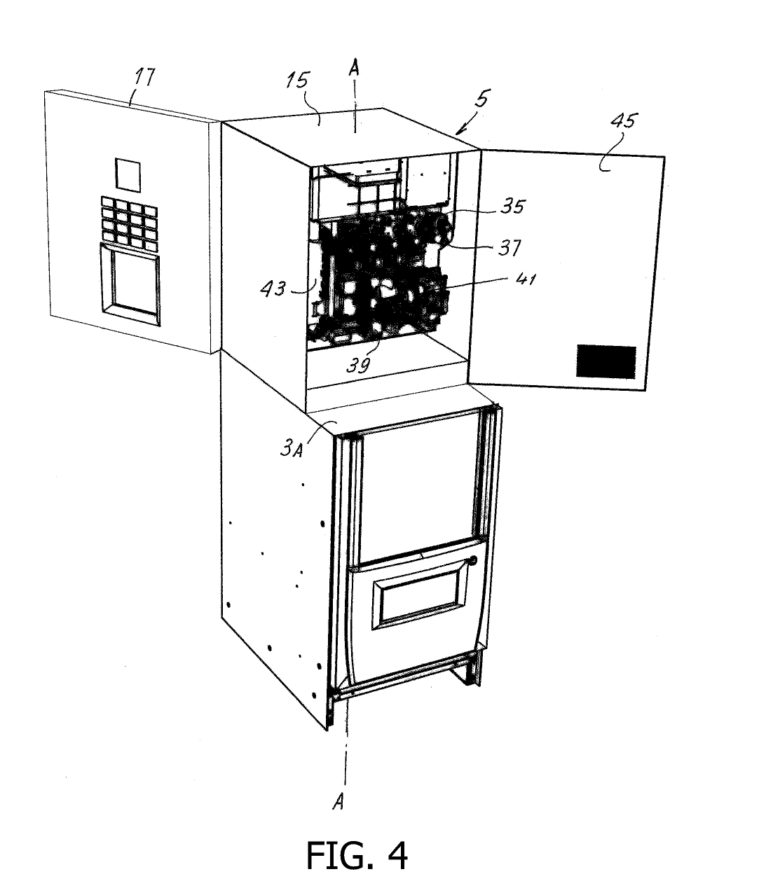

Inside enclosure 15 of the dispensing unit 5 there are seated the various components, such as a tank 21 for coffee grains, tanks 23 for freeze-dried products for making other beverages, such as tea, chocolate in cup, milk and others, a coffee grinding unit 25 for grinding the coffee grains contained in container 21, an infusion unit 27 for making coffee with the ground coffee powder obtained from coffee grinder 25, mixers 29 for mixing water, normally hot water coming from a boiler, with the ingredients coming from containers 23, one or more arms 31 whereon dispensing nozzles (not shown) are carried, connected to mixers 29 and to the infusion unit 27, a support surface 33 for the cup or other drink collecting container. These components are visible and accessible at the front by opening door 17 of the top dispensing unit 5. Another series of machine components is, on the other hand, accessible from the back, as is seen in FIG. 4. Among these components are the motor-driven dosing devices 35 for dosing the required amounts of ingredients from tanks 23, motors 37 for mixing the ingredients with hot water in the mixers, a pump 39 for pumping water into a boiler, boiler 41 for making hot water intended for making the drinks, an optional further separate boiler for making the hot water for coffee infusion, and others.

The components, devices and elements of the top dispensing unit 5 are accessible through a back opening 43 closed by a panel 45 or via a back door.

Some components, accessories or nozzles of the top dispensing unit 5 may be carried by the door or front door 17, in a per se known manner. On such door, for example, there may be arranged one or more of the following components: sugar dispenser, cup dispenser, stick or spoon dispenser. These components are omitted in the annexed schematic figures for greater simplicity.

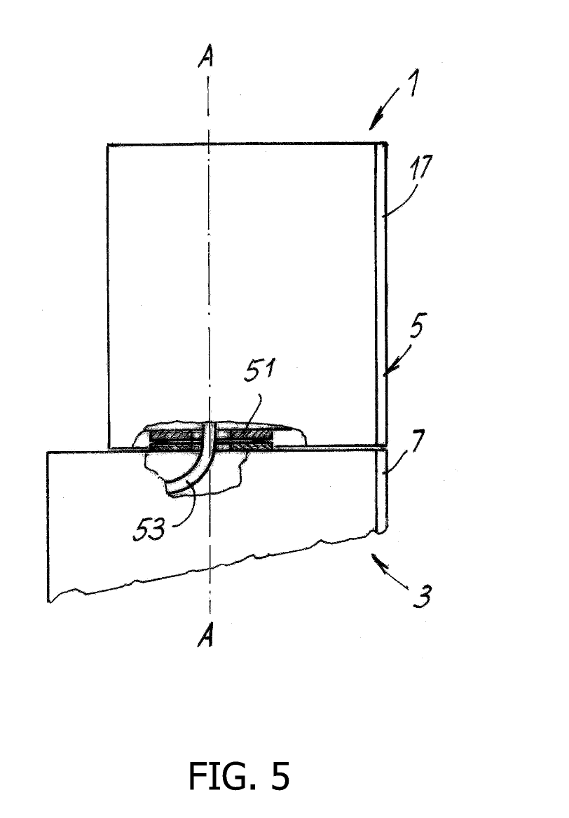

The seat or enclosure 15 that encloses the components of the top dispensing unit 5 is supported on the ceiling or top wall 3A of the bottom dispensing unit 3 so as to rotate about a substantially vertical axis indicated with A-A preferably arranged at the centre of the top wall 3A of the bottom dispensing unit. The top dispensing unit 5 may be supported (see FIG. 5) by a thrust bearing, that is, a fifth wheel or other component per se known, generally indicated with reference numeral 51, interposed between the bottom dispensing unit 3 and the top dispensing unit 5. In some embodiments, the thrust bearing is internally hollow for allowing the passage of connecting members, in particular electrical connections but also any hydraulic connections, towards the devices and components of the dispensing unit 5. In FIG. 5, these connecting elements are schematically indicated with reference numeral 53. These connecting elements 53 can enter inside the bottom dispensing unit 3 and optionally come out of it and/or be connected to internal components of the same bottom dispensing unit 3. For example, an electrical connection may be provided for the transfer of electronic data and commands from interface 19 located on the front door 17 of the dispensing unit 5 towards control and command members of the bottom dispensing unit 3. This is because interface 19 is preferably placed on the dispensing unit 5 that is located at a more ergonomically correct height for use by the user.

With an arrangement of this kind, seat 15 of the top dispensing unit 5 may rotate or oscillate relative to the bottom dispensing unit 3 about axis A-A. Preferably, in some embodiments there will be provided means for limiting the rotation angle, so that enclosure 15 of the top dispensing unit 5 cannot rotate by more than about 180° in one or the other direction relative to the bottom dispensing unit 3.

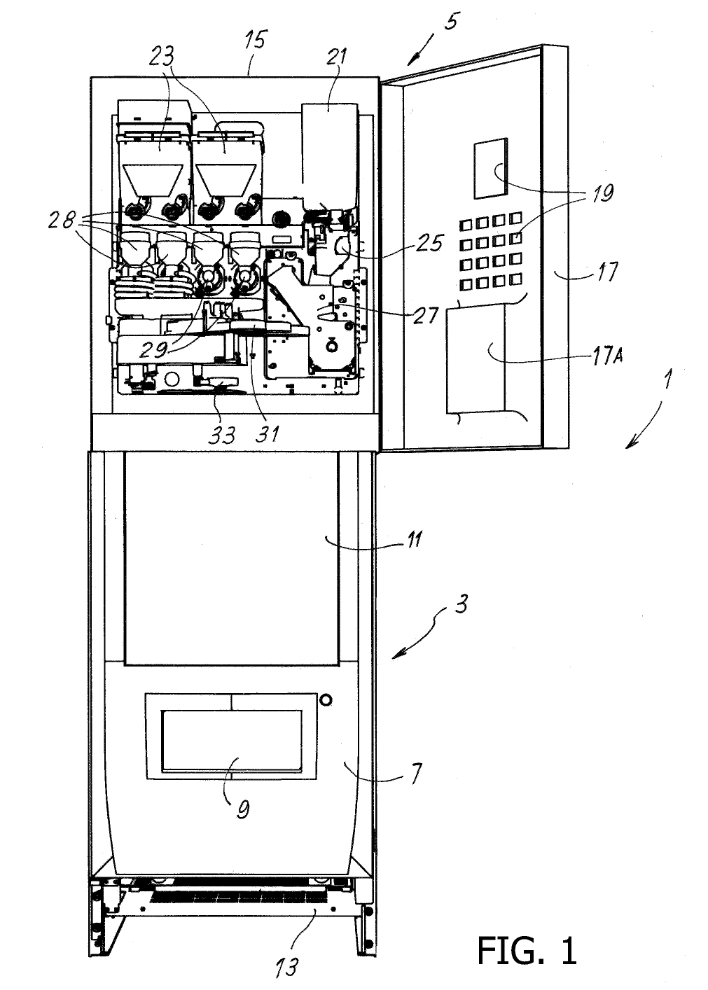

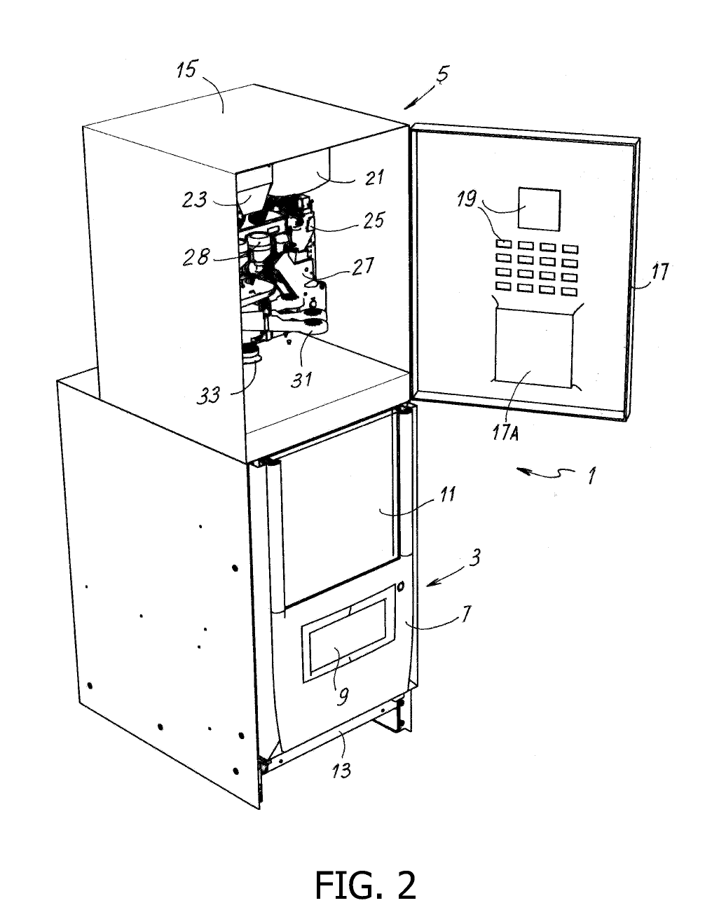

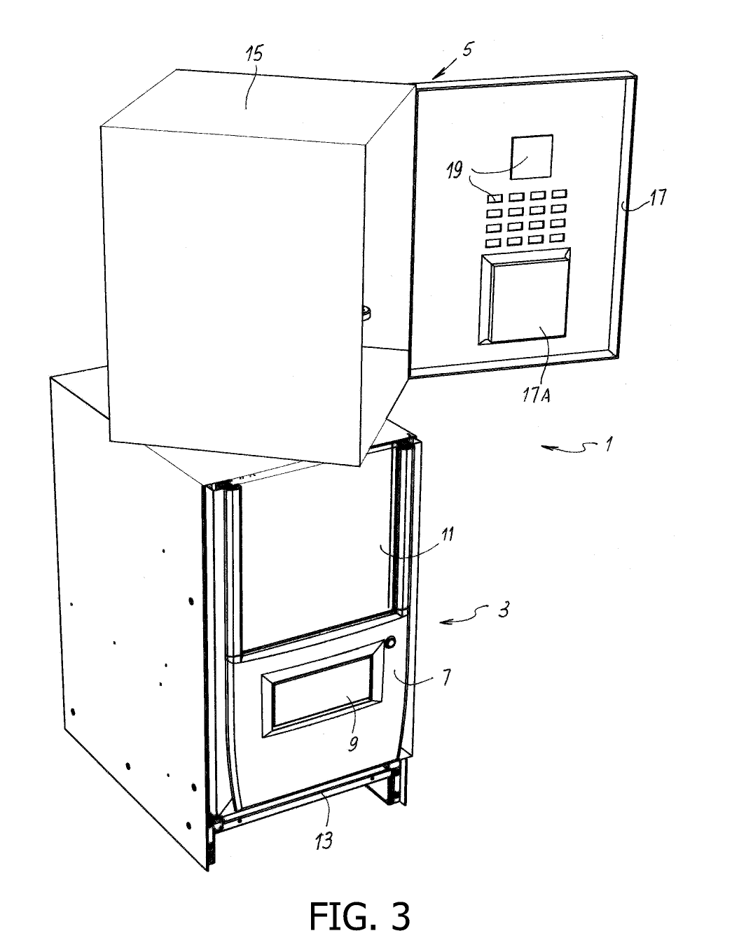

With this arrangement, the top dispensing unit 5 can switch from the setup of FIGS. 1 and 2 (wherein the top dispensing unit 5 has the front side facing the same side and aligned with the front side of the dispensing unit 3) to the setup of FIG. 4 (passing by the intermediate position of FIG. 3), wherein the top dispensing unit 5 is rotated by 180° to have the back side facing the same side as the front side of the bottom dispensing unit 3.

This system simplifies and substantially shortens maintenance, checking, cleaning works and optionally recharging the ingredients in the top dispensing unit 5. In fact, when the latter is in the setup of FIGS. 1 and 2, it is possible (with door 17 closed) to use the dispenser and (with front door 17 open) to perform the work operations on all the components, parts or devices that are accessible from the front side. By rotating the dispensing unit 5 by 180° around axis A-A and opening the back panel 45 it is possible to access all the components, parts or devices located at the back. In this way it is not necessary to move the entire automatic dispenser 1 away from the wall, against which it is normally placed with the back side, to carry out maintenance or fixing works on the components accessible from the back of the top dispensing unit 5.

Moreover, all the dispenser 1 remains completely operating also when the top dispensing unit 5 is rotated by 180° relative to its standard operating position. This allows those who carry out maintenance and fixing works, for example, to operate the top dispensing unit 5 to check the operation thereof even when it is rotated in the setup of FIGS. 3 and 4 with the back panel 45 open. It should be understood that in this setup, if the automatic dispenser 1 is placed against a wall, the front door 17 may be closed not to collide against the same wall.

In the example shown, the first dispensing unit 3, that is, the bottom unit for dispensing solid or packaged products, has a depth direction, that is, orthogonally to the central door 7, which is greater than the depth dimension of the second dispensing unit 5, that is, of the top drink dispensing unit. In the usage setup, the two front doors defined by door 7 and by door 17, are aligned whereas in the rotated setup, the back panel of the top dispensing unit 5 is retracted relative to door 7 of the bottom dispensing unit 3. This allows having a front support surface during maintenance operations.

In some embodiments, on the other hand, it is possible to provide for the front wall of the top dispensing unit to be refracted relative to the front wall of the bottom dispenser, so as to form a support surface that may be used by the machine user to dispense drinks and/or products.

In some embodiments, it is advantageously possible to provide for the top dispensing unit to exhibit a water tank located inside the seat or enclosure 15 of the dispensing unit 5, preferably accessible from the back side, that is, when the dispensing unit 5 is in the setup of FIG. 4. The water tank may be hung on the back panel 45, or it may be placed fixed within enclosure 15. This allows an easy filling of the water tank, an operation that in traditional dispensers is made difficult by the arrangement of the same tank.

It is understood that the drawing shows just one example, provided merely as a practical demonstration of the invention, which can vary in its forms and arrangements, without however departing from the scope of the concept underlying the invention. Any reference numbers in the appended claims are provided to facilitate reading of the claims with reference to the description and to the drawing, and do not limit the scope of protection represented by the claims.

1. An automatic dispenser comprising a first dispensing unit for dispensing solid or packaged food products and a second dispensing unit for dispensing drinks, overlapped to the first dispensing unit, characterised in that the second dispensing unit is turnably mounted relative to the first dispensing unit for allowing back access to the second dispenser without moving the first dispensing unit.

2. Automatic dispenser according to claim 1, characterised in that the second dispensing unit comprises a space for seating members and ingredient tanks for making drinks, said space being turnably mounted on the containment structure of the first dispensing unit.

3. Automatic dispenser according to claim 1, characterised in that said second dispensing unit is turnable about a substantially vertical axis and is supported on a substantially horizontal wall of the first dispensing unit.

4. Automatic dispenser according to claim 1, characterised in that said second dispensing unit comprises: a front door provided with an access for taking the drinks prepared and dispensed by the second dispensing unit; and a back closing door; said front door and said back door being openable for allowing access to the inside members of said second dispensing unit.

5. Automatic dispenser according to claim 1, characterised in that said second dispensing unit is mounted on the first dispensing unit by an annular support wherethrough connecting elements of internal components of the second dispensing unit pass.

6. Automatic dispenser according to claim 5, characterised in that said connecting elements penetrate within the first dispensing unit.

7. Automatic dispenser according to claim 1, characterised in that said first dispensing unit has a greater depth than the second dispensing unit.

8. Automatic dispenser according to claim 7, characterised in that in usage position said first dispensing unit and said second dispensing unit are positioned with respective front walls for picking up the food products and the drinks aligned with one another vertically, and in the rotated position of said second dispensing unit the back wall of the second dispensing unit is retracted relative to the front wall of the first dispensing unit.

9. Automatic dispenser according to claim 7, characterised in that in usage position said second dispensing unit is positioned with the front wall for picking up the drinks retracted relative to the front wall for picking up the products of said first dispensing unit.

10. Automatic dispenser according to claim 1, characterised in that said first dispensing unit comprises a front door with a door for picking up the food products dispensed by said first dispensing unit, the front door being openable for allowing access top the inside members of the first dispensing unit.

11. Automatic dispenser according to claim 1, characterised in that said second dispensing unit comprises at least one coffee dispenser.

12. Automatic dispenser according to claim 1, characterised in that said second dispensing unit comprises a water tank accessible from the back.
